(19) United States
(12) Patent Application Publication
(10) Pub. No.: US 2023/0316192 A1
(43) Pub. Date: Oct. 5, 2023

(54) SYSTEMS AND METHODS FOR GENERATING RISK SCORES BASED ON ACTUAL LOSS EVENTS

(71) Applicant: Cisco Technology, Inc., San Jose, CA (US)

(72) Inventors: Michael Roytman, Chicago, IL (US); Edward Thayer Bellis, IV, Evanston, IL (US)

(21) Appl. No.: 17/859,730

(22) Filed: Jul. 7, 2022

Related U.S. Application Data
(60) Provisional application No. 63/326,388, filed on Apr. 1, 2022.

(51) Int. Cl. G06Q 10/06

(52) U.S. Cl. CPC G06Q 10/0635

(57) ABSTRACT

In one embodiment, a method includes determining an attack tactic risk score for one or more attack tactics based on a dataset of actual loss events and determining an incident risk score for an incident based on the one or more attack tactic risk scores. The method also includes determining a priority value for an asset. The asset is associated with the incident. The method further includes generating an asset risk score for the asset based on the priority value of the asset and the incident risk score.

### RELATED APPLICATIONS

This application claims priority to U.S. Provisional Application No. 63/326,388, filed Apr. 1, 2022, which is hereby incorporated by reference in its entirety.

### TECHNICAL FIELD

The present disclosure relates generally to generating risk scores, and more specifically to systems and methods for generating risk scores based on actual loss events.

### BACKGROUND

Cybersecurity is the practice of protecting systems, networks, and/or programs from digital attacks. These cyberattacks are usually aimed at accessing, changing, and/or destroying sensitive information, extorting money from users, and/or interrupting normal business processes. To effectively implement cybersecurity measures, security operations analysts need to determine whether incidents are malicious and whether these incidents need to be further investigated. However, this proves challenging due to the high quantity of incidents.

### BRIEF DESCRIPTION OF THE DRAWINGS

FIG. 1 illustrates an example system for generating risk scores based on actual loss events;

FIG. 2 illustrates an example method for generating risk scores based on actual loss events; and

FIG. 3 illustrates an example computer system that may be used by the systems and methods described herein.

### DESCRIPTION OF EXAMPLE EMBODIMENTS

### Overview

According to an embodiment, a network component includes one or more processors and one or more computer-readable non-transitory storage media coupled to the one or more processors and including instructions that, when executed by the one or more processors, cause the network component to perform operations. The operations include determining an attack tactic risk score for one or more attack tactics based on a dataset of actual loss events and determining an incident risk score for an incident based on the one or more attack tactic risk scores. The operations also include determining a priority value for an asset associated with the incident. The operations further include generating an asset risk score for the asset based on the priority value of the asset and the incident risk score.

In some embodiments, the dataset of actual loss events comprises breach data and insurance data. In certain embodiments, the incident risk score is associated with a probability that the incident will lead to a financial loss of a business. In some embodiments, the incident risk score is associated with one of the following: a highest attack tactic risk score of the one or more attack tactics or an average attack tactic risk score of the one or more attack tactics. In some embodiments, the incident risk score is one of a plurality of incident risk scores associated with the asset.

In certain embodiments, the attack tactic risk score for each of the one or more attack tactics is a value within a range of 1 to 100. In some embodiments, the incident risk score for the incident is a value within a range of 1 to 100. In certain embodiments, the priority value of the asset is a value within a range of 1 to 10. In some embodiments, the asset risk score is a value within a range of 1 to 1000. Generating the asset risk score for the asset may be based on the priority value of the asset and the plurality of incident risk scores. For example, generating the asset risk score for the asset may include multiplying the priority value of the asset by the one or more incident risk scores associated with the asset.

According to another embodiment, a method includes determining an attack tactic risk score for one or more attack tactics based on a dataset of actual loss events and determining an incident risk score for an incident based on the one or more attack tactic risk scores. The method also includes determining a priority value for an asset associated with the incident. The method further includes generating an asset risk score for the asset based on the priority value of the asset and the incident risk score.

According to yet another embodiment, one or more computer-readable non-transitory storage media embody instructions that, when executed by a processor, cause the processor to perform operations. The operations include determining an attack tactic risk score for one or more attack tactics based on a dataset of actual loss events and determining an incident risk score for an incident based on the one or more attack tactic risk scores. The operations also include determining a priority value for an asset associated with the incident. The operations further include generating an asset risk score for the asset based on the priority value of the asset and the incident risk score.

Technical advantages of certain embodiments of this disclosure may include one or more of the following. Certain embodiments of this disclosure use a prioritization model to prioritize incidents using real-world data rather than prioritizing alerts based on either confidence in the alert and/or a Security Operations Center (SOC) analyst relying on their expertise to identify an alert as being high risk. Certain embodiments of this disclosure use real-world data to prioritize threats and assign a probability of attack. With the understanding that certain entities may not have the ability to remediate all identified security incidents, this disclosure assists entities in sifting through the noise to focus on the threats that pose immediate and/or severe threats. For smaller teams, this may include prioritizing incidents. For larger teams, which may attempt to address every incident and may have a larger SOC, this may include prioritizing staffing and capacity constraints.

Certain embodiments of this disclosure determine data-driven probabilities of attack for each incident. With this approach to incident prioritization, risk may be better quantified and understood by groups outside security risk management teams. For example, financial planning teams, executive leadership teams, and board members can view and monitor a data-driven and quantifiable approach to security incidents over time. Certain embodiments of this disclosure use real-time data to inform the classification and prioritization of incidents, which allows security teams to effectively remediate the incidents.

In certain embodiments, Endpoint Detection and Response (EDR) solutions are judged on MITRE Adversarial Tactics, Techniques, and Common Knowledge (ATT&CK) coverage. The risk model of this disclosure may provide complete coverage by using more synthesized data, a risk-based framework, and/or prioritized tactics and/or techniques. Certain prioritization models of this disclosure use real-world incidents that have happened in the past to help determine the risk and severity of current day incidents. The incidents may be quantified and/or correlated to determine the probability and likelihood that a certain technique will actually cause a loss. In certain embodiments, the real-world data is used to determine the likelihood that a particular incident will lead to a breach and the severity of that breach.

Other technical advantages will be readily apparent to one skilled in the art from the following figures, descriptions, and claims. Moreover, while specific advantages have been enumerated above, various embodiments may include all, some, or none of the enumerated advantages.

### Example Embodiments

This disclosure describes systems and methods for generating risk scores based on actual loss events. Certain cybersecurity technologies such as Extended Detection and Response (XDR) monitor and/or mitigate cyber threats. In particular, XDR is used to collect and/or correlate data across various network points (e.g., email, endpoints, servers, cloud workloads, networks, etc.), which provides visibility and context into advanced threats. XDR may be used to analyze, prioritize, and/or remediate threats to reduce and/or prevent data loss and security breaches. In certain embodiments, XDR increases visibility and context into threats such that events that were not previously addressed may surface to a higher level of awareness. This increased visibility may allow security teams to reduce and/or eliminate any further impact. This increased visibility may also help reduce the severity and scope of the attack.

EDR is a predecessor to XDR. EDR improved malware detection and remediation over the antivirus detection approach. EDR solutions differ from XDR in that they focus on endpoints (e.g., laptops) and record system activities and events to assist security teams (e.g., the SOC) in gaining the visibility needed to uncover incidents that would normally not be detected. XDR extends the range of EDR to encompass additional security solutions. XDR provides higher visibility by collecting and correlating threat information and employing analytics and automation to help detect current and future attacks.

Embodiments of this disclosure determine risk scores (e.g., risk-based XDR) using a dataset of actual loss events. In certain embodiments, real-time data is used to inform the risk analysis. Incidents may be classified and alerts may be prioritized to facilitate triage incidents. In some embodiments, the data is based on internal information specific to what an entity may observe across its products and from its customers.

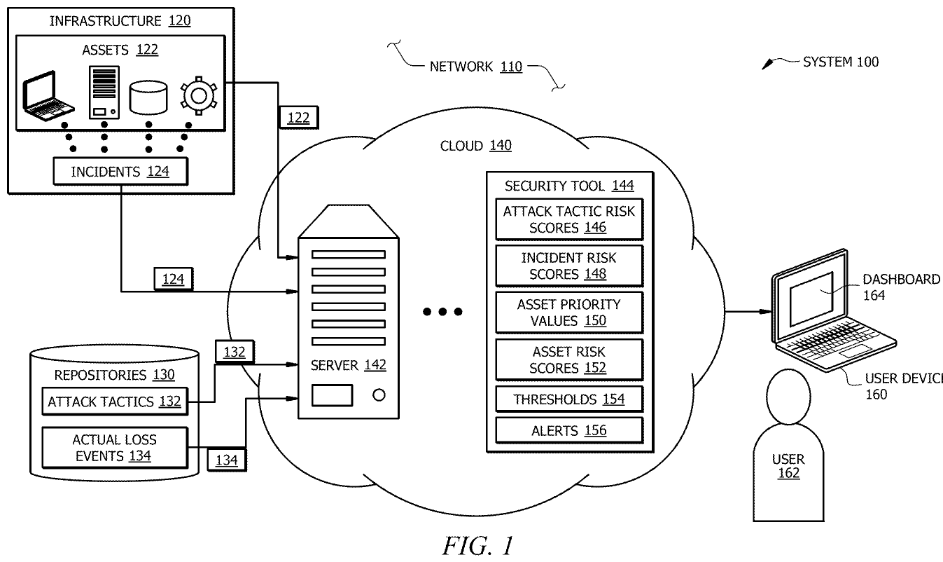

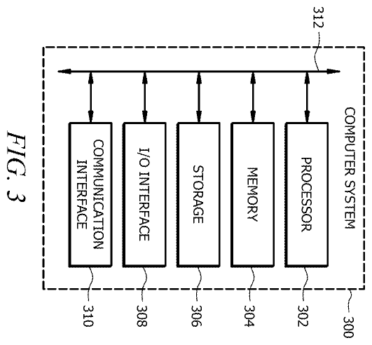

FIG. 1 illustrates an example system 100 for generating risk scores based on actual loss events. System 100 or portions thereof may be associated with an entity, which may include any entity, such as a business, company, or enterprise, that generates risk scores. In certain embodiments, the entity may be a service provider that provides security services. The components of system 100 may include any suitable combination of hardware, firmware, and software. For example, the components of system 100 may use one or more elements of the computer system of FIG. 3. In the illustrated embodiment of FIG. 1, system 100 includes a network 110, an infrastructure 120, assets 122, incidents 124, repositories 130, attack tactics 132, actual loss events 134, a cloud 140, a server 142, a security tool 144, attack tactic risk scores 146, incident risk scores 148, asset priority values 150, asset risk scores 152, a user device 160, a user 162, and a dashboard 164.

Network 110 of system 100 is any type of network that facilitates communication between components of system 100. Network 110 may connect one or more components of system 100. One or more portions of network 110 may include an ad-hoc network, the Internet, an intranet, an extranet, a virtual private network (VPN), an Ethernet VPN (EVPN), a local area network (LAN), a wireless LAN (WLAN), a virtual LAN (VLAN), a wide area network (WAN), a wireless WAN (WWAN), a software-defined wide area network (SD-WAN), a metropolitan area network (MAN), a portion of the Public Switched Telephone Network (PSTN), a cellular telephone network, a Digital Subscriber Line (DSL), an Multiprotocol Label Switching (MPLS) network, a 3G/4G/5G network, a Long Term Evolution (LTE) network, a cloud network, a combination of two or more of these, or other suitable types of networks. Network 110 may include one or more different types of networks. Network 110 may be any communications network, such as a private network, a public network, a connection through the Internet, a mobile network, a WI-FI network, etc. Network 110 may include a core network, an access network of a service provider, an Internet service provider (ISP) network, and the like. One or more components of system 100 may communicate over network 110.

Network 110 may include one or more nodes. Nodes are connection points within network 110 that receive, create, store and/or send data along a path. Nodes may include one or more redistribution points that recognize, process, and forward data to other nodes of network. Nodes may include virtual and/or physical nodes. In certain embodiments, nodes include one or more virtual machines, hardware devices, bare metal servers, and the like. In some embodiments, nodes may include data communications equipment such as computers, routers, servers, printers, workstations, switches, bridges, modems, hubs, and the like. Nodes may use static and/or dynamic routing to send data to and/or receive data to other nodes of system 100.

Infrastructure 120 of system 100 is the hardware, software, services, and/or facilities associated with an entity (e.g., a business). Infrastructure 120 provides for network connectivity and communication between users, devices, applications, the Internet, and the like. Infrastructure 120 may include one or more wired and/or wireless networks. For example, infrastructure 120 may include one or more wired networks such that data flows over cables. In certain embodiments, the cables may connect to an interface card in an end device at one end and to an Ethernet port on a network switch or router at the other end. As another example, infrastructure 120 may include one or more wireless networks such that data flows over the air via radio waves. These signals may travel from the end device to a wireless access point, which is connected to network 110.

Infrastructure 120 of system 100 includes assets 122. Assets 122 are valuable components of an entity's infrastructure 120 that support information-related activities. Assets 122 may include hardware (e.g., routers, gateways, switches, firewalls, hubs, printers, servers, hosts, desktop computers, laptops, wireless access points, etc.), software (e.g., an operating system (OS), applications, updates, patches, etc.), and/or confidential information. Applications perform specific functions and include web browsers, multimedia software, content access software, enterprise software, database software, and the like. In certain embodiments, a plurality of similar assets 122 may be assigned to a group. For example, a plurality of assets 122 that utilize a Windows OS may be assigned to a group. Assets 122 may be identified by one or more owners of assets 122, one or more administrators of assets 122, one or more hosts (e.g., a cloud host) of assets 122, the network accessibility of assets 122, a combination thereof, and the like. In certain embodiments, assets 122 are identified by an asset identifier, an Internet Protocol (IP) address, a host name, a media access control (MAC) address, a Uniform Resource Locator (URL) address, notes, a combination thereof, etc.

In certain embodiments, assets 122 of infrastructure 120 may be associated with one or more incidents 124. Incidents 124 are intrusion events that could potentially lead to a financial loss of a business associated with infrastructure 120. Financial loss may refer to any financial loss of a business or a financial loss exceeding a predetermined threshold (e.g., a monetary value of $10,000, $1,000,000, etc.). In certain embodiments, incidents 124 violate one or more security policies associated with infrastructure 120. Incidents 124 may be associated with one or more of the following: data breach events, malware, Denial of Service (DoS), unauthorized administrative access, web site defacement, compromise of system integrity, hoax, theft, damage, privilege escalation, insider threat, phishing, man-in-the-middle attacks, and the like. Certain incidents 124 are more important than others to the availability, confidentiality, and/or integrity of assets 122. For example, port scan detection may track port scanning activity within infrastructure 120, even if a security policy may not specifically prohibit port scanning or see it as a high priority threat. As another example, certain events may indicate hosts within infrastructure 120 have been compromised and are participating in distributed denial-of-service (DDoS) attacks, which may violate one or more security policies associated with infrastructure 120.

Incidents 124 may be identified by the type of incident (e.g., data breach, malware, etc.), information about the affected assets (e.g., the host name and/or IP, the time zone, the purpose or function of the host, etc.), information about the sources of the attack (e.g., the host name and/or IP, the time zone, any contact with an attacker, an estimated cost of handling the incident, etc.), a description of the incident (e.g., dates, methods of intrusion, the intruder tools involved, the software versions and/or patch levels, any intruder tool output, the details of vulnerabilities exploited, the source of the attack, any other relevant information, etc.), a combination thereof, and the like.

Repositories 130 are central locations that store and/or manage data. Repositories 130 may include one or more digital repositories, online repositories, open access repositories, databases, subject-based repositories, Git repositories, a combination thereof, and the like. Repositories 130 may be stored on one or more file systems, hosted on computer clusters, hosted in cloud storage, etc. Repositories 130 may be public or private. Public repositories 130 are accessible to all Internet users, whereas private repositories 130 are accessible to those explicitly granted access. In the illustrated embodiment of FIG. 1, repositories 130 store attack tactics 132 and actual loss events 134.

Attack tactics 132 are adversary tactics, techniques, procedures, and/or a combination thereof that cyber threat actors use to plan and/or execute cyberattacks on business infrastructures 120. In some embodiments, attack tactics 132 are stored in a globally accessible knowledge base (e.g., the MITRE ATT&CK database). Tactics represent the reasons adversaries perform specific actions. Tactics may be associated with one or more of the following: a reconnaissance tactic (e.g., a port scan); a resource development tactic; an initial access tactic (e.g., phishing); an execution tactic (e.g., native API); a persistence tactic; a privilege escalation tactic; a defense evasion tactic; a credential access tactic (e.g., unsecured credentials); a discovery tactic (e.g., network sniffing); a lateral movement tactic; a collection tactic; a command-and-control tactic (e.g., web service); an exfiltration tactic; an impact tactic, and the like.

Each tactic may include one or more techniques. Techniques represent tactical goals received by adversaries for performing specific actions. Attack tactics 132 may include techniques such as active scanning, phishing for information, establishing accounts, interacting with native OS application programming interfaces (APIs) to execute behaviors, forcing authentication, hijacking execution flows, obtaining, developing, and/or staging capabilities, deploying containers, and the like. In certain embodiments, tactics may include one or more techniques. For example, a reconnaissance tactic may include techniques that involve adversaries actively and/or passively gathering information (e.g., details of the victim's organization) that can be used to support targeting. As another example, a resource development tactic may include techniques that involve adversaries purchasing, creating, and/or compromising resources (e.g., accounts) that can be used to support targeting. As still another example, an initial access tactic may include techniques (e.g., targeted spear phishing) that use entry vectors to gain access within infrastructure 120. In certain embodiments, attack tactics 132 may include a single tactic, multiple tactics, a single technique, multiple techniques, and/or any combination thereof.

Actual loss events 134 represent any information related to historical losses due to security incidents. Actual loss events 134 may include incident tracking data, victim demographic data, incident description data, incident discovery data, incident response data, incident impact assessment data, and the like. Actual loss events 134 may identify the actor behind a particular incident (e.g., an external, internal, or partner actor), the method(s) used by the actor (e.g., malware, hacking, social, misuse, physical, error, environmental, etc.), information about affected assets 122 (e.g., ownership, management, hosting, accessibility, cloud, etc.), information related to how assets 122 were affected (confidentiality, possession, integrity, authenticity, availability, utility, etc.), and the like.

Actual loss events 134 may be stored in one or more public and/or private repositories 120. For example, information related to actual loss events 134 may be retrieved from the Vocabulary for Event Recording and Incident Sharing (VERIS) repository (e.g., the VERIS Community Database (VCDB)). VERIS is a set of metrics that provide a common language for describing security incidents in a structured manner. As another example, information related to actual loss events 134 may be retrieved from a private database of a business. The business's private database may include actual loss events 134 that directly or indirectly led to a financial loss of the business.

In certain embodiments, actual loss events 134 provide a historical view of cyber loss events. Actual loss events 134 may include one or more of the following characteristics: a case type, a case status, an affected count, an accident date, a source of the loss, a type of loss, an actor, a loss amount, a company size, a company type, a number of employees, an industry code, a geography, etc. In certain embodiments, actual loss events 134 are associated with one or more of the following types of cyber risks: breach data, insurance data, cyber extortion, unintentionally disclosed data, physically lost or stolen data, unauthorized data collection, unauthorized contact or disclosure, fraudulent use/account access, network/website disruption, phishing, spoofing, social engineering, skimming, physical tampering, information technology (IT) configuration/implementation errors, IT processing errors, and the like.

Actual loss events 134 may be collected from private sources and/or publicly available sources. For example, actual loss events 134 may be collected by a private organization (e.g., a business or entity) that monitors incidents 124. As another example, actual loss events 134 may be collected from publicly available sources such as the VERIS repository or the Advisen database. Actual loss events 134 may be categorized by industry (e.g., education, financial, public sector, hospitality, retail, etc.). In certain embodiments, a dataset of actual loss events 134 is based on a particular industry. In certain embodiments, attack tactics 132 and actual loss events 134 are communicated to cloud 140.

Cloud 140 of system 100 refers to servers accessed via the Internet. Cloud 140 may be a private cloud, a public cloud, or a hybrid cloud. Cloud 140 may be associated with one or more of the following cloud computing service models: Software-as-a-Service (SaaS), Platform-as-a-Service (PaaS), Infrastructure-as-a-Service (IaaS), Function-as-a-Service (FaaS), etc. In the illustrated embodiment of FIG. 1, server 142 of system 100 is hosted in cloud 140. Server 142 may be physically located in a data center. Server 142 includes software and hardware and has computing and storage capabilities. In the illustrated embodiment of FIG. 1, sever 142 hosts security tool 144.

Security tool 144 of system 100 is a software program used by server 140 to determine risk scores. In certain embodiments, security tool 144 interoperates with other network components (e.g., infrastructure 120, repositories 130, agents, endpoints, clouds, security products, etc.) to determine risk scores. Security tool 144 may gather, combine, and/or correlate threat intelligence to efficiently respond to incidents 124. In certain embodiments, security tool 144 generates attack tactic risk scores 146, incident risk scores 148, asset priority values 150, and asset risk scores 152.

Each attack tactic risk score 146 represents a probability that associated attack tactic 132 will lead to a financial loss of a business. Attack tactic risk scores 146 may be assigned to attack tactics 132 based on actual loss events 134. In certain embodiments, security tool 144 analyzes actual loss events 134 for ease of vulnerability exploitation, malware exploitation, active breaches (e.g., an active Internet breach), popularity as a target, and the like. In some embodiments, attack tactic risk scores 146 are based on internal information specific to what a business may observe across its products and/or from its customers.

In some embodiments, security tool 144 may take into account unique, common identifiers for publicly known cybersecurity vulnerabilities (e.g., Common Vulnerabilities and Exposures (CVE) Identifiers), community-developed lists of software and/or hardware weakness types (e.g., Common Weakness Enumeration (CWE) identifiers), Web Application Security Consortium (WASC) identifiers, normalized Common Vulnerability Scoring System (CVSS) scores from the National Vulnerability Database, and the like to generate attack tactic risk scores 146. For example, security tool 144 may use one or more algorithms to layer information assessed from actual loss events 134 onto a base CVSS score associated with attack tactic 132 to generate attack tactic risk score 146 for that particular attack tactic 132. In certain embodiments, attack tactic risk score 146 for each attack tactic 132 is a value within a range of 0 (or 1) to 10 such that attack tactic risk score 146 of 0 (or 1) indicates no probability that associated attack tactic 134 will lead to a financial loss of a business and an attack tactic risk score 146 of 10 indicates a maximum probability that associated attack tactic 134 will lead to a financial loss of a business.

Each incident 124 within infrastructure 120 may be associated with one or more attack tactics 132. For example, a data breach incident may be associated with a reconnaissance tactic, a phishing technique, a resource development tactic, and/or a compromise accounts technique. As another example, a malware incident may be associated with an Execution tactic, a Defense Evasion tactic, and a Process Injection technique.

In certain embodiments, security tool 144 incident risk scores 148 to incidents 124. Each incident risk score 148 represents a probability that associated incident 124 will lead to a financial loss of a business. Incident risk scores 148 may be based on attack tactics 132. For example, incident risk score 148 assigned to incident 124 may be the highest attack tactic risk score 146 of the one or more attack tactics 132 associated with incident 124. As another example, incident risk score 148 assigned to incident 124 may be the average attack tactic risk score 146 of one or more attack tactics 132 associated with incident 124. In certain embodiments, incident risk score 148 for each incident 124 is a value within a range of 0 (or 1) to 100 such that incident risk score 148 of 0 (or 1) indicates no probability that associated incident 124 will lead to a financial loss of a business and incident risk score 148 of 10 indicates a maximum probability that associated incident 124 will lead to a financial loss of a business.

In certain embodiments, security tool 144 assigns asset priority values 150 to assets 122. Asset priority values 150 indicate the importance of each asset 122 to a party (e.g., a business associated with infrastructure 120). In certain embodiments, asset priority value 150 for each asset 122 is a value within a range of 0 (or 1) to 10 such that a value of 0 (or 1) indicates no importance of asset 122 to the party and a value of 10 indicates a maximum importance of asset 122 to the party. For example, a chief executive officer (CEO)'s device may be assigned an asset priority of 10, whereas a rarely used printer may be assigned an asset priority of 1. In certain embodiments, asset priority value 150 may refer to a priority value assigned to a group of assets 122. Security tool 144 may determine asset priority value 150 for a group of assets 122 by averaging asset priority values 150 for assets 122 of the group, by taking a highest asset priority value 150 of assets 122 of group, and the like.

Asset priority values 150 may be assigned to each asset 122 manually and/or automatically. For example, asset priority values 150 may be individually assigned by an administrator. As another example, asset priority values 150 may be automatically assigned using a software tool (e.g., Kenna). In certain embodiments, asset priority values 150 are determined based on an identification of asset 122, metadata associated with asset 122, tags associated with asset 122, details of asset 122 (e.g., an IP address, a host name, a MAC address, an operating system, etc.), users (e.g., a CEO, a financial analyst, etc.) of asset 122, and the like.

In certain embodiments, security tool 144 generates asset risk scores 152 for one or more assets 122. Each asset risk score 152 represents a probability that asset 122 will lead to a financial loss of a business. In certain embodiments, asset risk scores 152 are determined based on asset priority values 150 and incident risk scores 148. For example, asset risk score 152 for asset 122 may be generated by multiplying asset priority value 150 of asset 122 (or group of assets 122) by the one or more incident risk scores 148 associated with asset 122. As another example, asset risk score 152 for asset 122 may be generated by multiplying asset priority value 150 of a group of assets 122 by the one or more incident risk scores 148 associated with the group of assets 122. In certain embodiments, asset risk score 152 is a value within a range of 0 (or 1) to 1000 such that a value of 0 indicates no probability that asset 122 will lead to financial loss of a business and a value of 1000 indicates a maximum probability that asset 122 will lead to financial loss of the business.

In certain embodiments, thresholds 154 are used to classify asset risk scores 152. For example, asset risk scores 152 having a value equal to or below first predetermined threshold 154 (e.g., a score of 330) may indicate a low probability that associated asset 122 will lead to a financial loss of a business. As another example, asset risk scores 152 having a value above first predetermined threshold 154 (e.g., a score of 330) but below second predetermined threshold 154 (e.g., a score of 670) may indicate a medium probability that associated asset 122 will lead to a financial loss of a business. As still another example, asset risk scores 152 having a value equal to or above second predetermined threshold 154 (e.g., a score of 670) may indicate a high probability that associated asset 122 will lead to a financial loss of a business.

In some embodiments, thresholds 154 are used to prioritize asset risk scores 152. For example, security tool 144 may prioritize asset risk scores 152 with values equal to or greater than threshold 154 (e.g., 670) over asset risk scores 152 with values lower than threshold 154. In some embodiments, security tool 144 prioritizes asset risk scores 152 based on a particular quantity of asset risk scores 152 having the greatest probability that associated assets 122 will lead to a financial loss of a business. For example, security tool 144 may prioritize a predetermined number (e.g., 10, 50, or 100) of asset risk scores 152 with the highest values. In certain embodiments, security tool 144 may use one or more conditions (e.g., thresholds 154) to generate alerts 156.

Alerts 156 are notifications based on configured conditions. In certain embodiments, alerts 156 notify user 162 of any issues associated with incidents 124. For example, alerts 156 may notify user 162 which asset risk scores 152 exceed predetermined threshold 154. As another example, alerts 156 may notify user 162 which asset risk scores 152 are in the top predetermined number (e.g., 100) of asset risk scores 152. Alerts 156 may generate one or more aural tones, aural phrases, visual representations (e.g., graphs, charts, tables, lists, or any other suitable format) to notify user 162 of the probability that one or more assets 122 will lead to a financial loss of a business. In some embodiments, alerts 156 provide an overall view of one or more incidents 124 that allows users 162 to quickly determine which incidents 124 require immediate attention. In certain embodiments, alerts 156 generate one or more reports that provide visual representations of incident-related information. In certain embodiments, security tool 144 generates conditions that use thresholds 154 to trigger alerts 156.

User device 160 of system 100 includes any user equipment that can receive, create, process, store, and/or communicate information. User device 160 may include one or more workstations, desktop computers, laptop computers, mobile phones (e.g., smartphones), tablets, personal digital assistants (PDAs), wearable devices, and the like. In certain embodiments, user device 160 includes a liquid crystal display (LCD), an organic light-emitting diode (OLED) flat screen interface, digital buttons, a digital keyboard, physical buttons, a physical keyboard, one or more touch screen components, a graphical user interface (GUI), and/or the like. User device 160 may be located in any suitable location to receive and communicate information to user 162 of system 100. In the illustrated embodiment of FIG. 1, user device 160 alerts user 162 of the probability that one or more assets 122 will lead to a financial loss of a business.

User 162 of system 100 is a person or group of persons who utilizes user device 160 of system 100. User 162 may be associated with one or more accounts. User 162 may be a local user, a remote user, an administrator, a customer, a company, a combination thereof, and the like. User 162 may be associated with a username, a password, a user profile, etc. User 162 of user device 160 is a security analyst, a financial analyst, etc.

Dashboard 164 of system 100 allows user 162 to visualize any security issues associated with infrastructure 120. In certain embodiments, dashboard 164 provides an overall security view of one or more incidents 124 and/or asset risk scores 152 that allows user 162 to quickly determine the probability that asset 122 will lead to a financial loss of a business. Dashboard 164 may display one or more graphs, charts, tables, lists, or any other suitable format to represent the incident-related information. In certain embodiments, dashboard 164 provides a visual representation of one or more assets 122, incidents 124, repositories 130, attack tactics 132, actual loss events 134, attack tactic risk scores 146, incident risk scores 148, asset priority values 150, and asset risk scores 152 to user 162.

In operation, server 142 of cloud 140 receives data associated with assets 122 (e.g., applications, firewalls, devices, printers, etc.) and incidents 124 (e.g., a data breach incident, a malware incident, etc.) from infrastructure 120. Security tool 144 also receives data associated with attack tactics 132 (e.g., a reconnaissance tactic, a resource development tactic, an initial access tactic, etc.) and actual loss events 134 (e.g., breach data and/or insurance data) from repositories 130. Security tool 144 determines attack tactic risk scores 146 (e.g., a score of 0 to 100) for each attack tactic 132 based in part on a dataset of actual loss events 134. Security tool 144 also determines incident risk scores 148 (e.g., a score of 0 to 100) for incidents 124 based on attack tactic risk scores 146. Each incident risk score 148 is associated with a probability that incident 124 will lead to a financial loss of a business. Security tool 144 determines asset priority value 150 (e.g., a score of 0 to 10) for each asset 122 and generates asset risk score 152 (e.g., a score of 0 to 1000) for asset 122 by multiplying asset priority value 150 by incident risk score 148 associated with asset 122. Security tool 144 compares asset risk score 152 to predetermined threshold 154 and generates alert 156 if asset risk score 152 exceeds predetermined threshold 154. As such, system 100 allows administrators to quickly determine which assets 122 are more likely to lead to a financial loss of a business.

Although FIG. 1 illustrates a particular number of networks 110, infrastructures 120, assets 122, incidents 124, repositories 130, attack tactics 132, actual loss events 134, clouds 140, servers 142, security tools 144, attack tactic risk scores 146, incident risk scores 148, asset priority values 150, asset risk scores 152, user devices 160, users 162, and dashboards 164, this disclosure contemplates any suitable number of networks 110, infrastructures 120, assets 122, incidents 124, repositories 130, attack tactics 132, actual loss events 134, clouds 140, servers 142, security tools 144, attack tactic risk scores 146, incident risk scores 148, asset priority values 150, asset risk scores 152, user devices 160, users 162, and dashboards 164. For example, system 100 may include more than one infrastructure 120.

Although FIG. 1 illustrates a particular arrangement of network 110, infrastructure 120, assets 122, incidents 124, repositories 130, attack tactics 132, actual loss events 134, cloud 140, server 142, security tool 144, attack tactic risk scores 146, incident risk scores 148, asset priority values 150, asset risk scores 152, user device 160, user 162, and dashboard 164, this disclosure contemplates any suitable arrangement of network 110, infrastructure 120, assets 122, incidents 124, repositories 130, attack tactics 132, actual loss events 134, cloud 140, server 142, security tool 144, attack tactic risk scores 146, incident risk scores 148, asset priority values 150, asset risk scores 152, user device 160, user 162, and dashboard 164. For example, repositories 130 may be located in cloud 140.

Furthermore, although FIG. 1 describes and illustrates particular components, devices, or systems carrying out particular actions, this disclosure contemplates any suitable combination of any suitable components, devices, or systems carrying out any suitable actions.

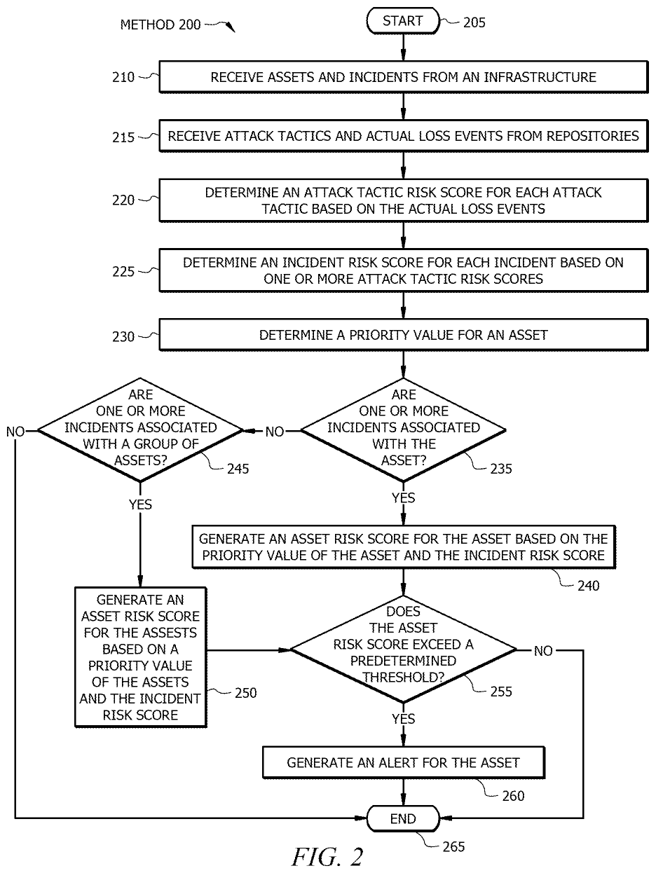

FIG. 2 illustrates an example method 200 for generating risk scores based on actual loss events. Method 200 begins at step 205. At step 210 of method 200, a security tool receives assets and incidents from an infrastructure. For example, referring to FIG. 1, security tool 144 of system 100 may receive information associated with assets 122 and incidents 124 from infrastructure 120. Assets are valuable components of an entity's infrastructure that support information-related activities. Assets 122 may include routers, gateways, switches, firewalls, hubs, printers, servers, hosts, desktop computers, laptops, wireless access points, applications, updates, patches, confidential information, and the like. Incidents are intrusion events that could potentially lead to a financial loss of a business associated with the infrastructure. Incidents may include data breaches, malware, Denial of Service (DoS), unauthorized administrative access, web site defacement, compromise of system integrity, hoax, theft, damage, privilege escalation, insider threat, phishing, malware, man-in-the-middle attacks, and the like. Method 200 then moves from step 210 to step 215.

At step 215 of method 200, the security tool receives attack tactics and actual loss events from repositories. For example, referring to FIG. 1, security tool 144 of system 100 may receive attack tactics 132 and actual loss events 134 from repositories 130. Attack tactics are adversary tactics, techniques, and/or procedures that cyber threat actors use to plan and/or execute cyberattacks on business infrastructures. Attack tactics may include reconnaissance tactics (e.g., port scans), resource development tactics, initial access tactics, execution tactics, persistence tactics, privilege escalation tactics, defense evasion tactics, credential access tactics, discovery tactic (e.g., network sniffing), lateral movement tactics, collection tactics, command-and-control tactics (e.g., web service), exfiltration tactics, impact tactics, and the like. Attack tactics may include techniques such as active scanning, phishing for information, establishing accounts, interacting with native OS APIs to execute behaviors, forcing authentication, hijacking execution flows, obtaining, developing, and/or staging capabilities, deploying containers, and the like. Method 200 then moves from step 215 to step 220.

At step 220 of method 200, the security tool determines an attack tactic risk score for each attack tactic based on the actual loss events. For example, referring to FIG. 1, security tool 144 may determine attack tactic risk scores 146 for each attack tactic 132 based on actual loss events 134. Security tool may use one or more algorithms to layer information assessed from actual loss events onto a base CVSS score associated with an attack tactic to generate the attack tactic risk score for the attack tactic. Method 200 then moves from step 220 to step 225.

At step 225 of method 200, the security tool determines an incident risk score for each incident based on one or more attack tactic risk scores. For example, referring to FIG. 1, security tool 144 may determine incident risk scores 148 for incidents 124 based on one or more attack tactic risk scores 146. Each incident risk score represents a probability that the associated incident will lead to a financial loss of a business. In certain embodiments, the incident risk score for a particular incident may be the highest attack tactic risk score of the one or more attack tactics associated with the incident. In some embodiments, the incident risk score for a particular incident may be the average attack tactic risk score of one or more attack tactics associated with incident. Method 200 then moves from step 225 to step 230.

At step 230 of method 200, the security tool determines a priority value for an asset. Referring to FIG. 1, security tool 144 may determine asset priority value 150 for asset 122. Asset priority values indicate the importance of each asset to a party (e.g., a business associated with infrastructure). Method 200 then moves from step 230 to step 235, where the security tool determines whether one or more incidents are associated with the asset. For example, referring to FIG. 1, security tool 144 may determine whether one or more incidents 124 such as data breaches or malware are associated with asset 122. If, at step 235, the security tool determines that one or more incidents are associated with the asset, method 200 moves from step 235 to step 240, where the security tool generates an asset risk score for the asset based on the priority value of the asset and the incident risk score. For example, referring to FIG. 1, security tool 144 may generate asset risk score 152 for asset 122 by multiplying asset priority value 150 of asset 122 by incident risk score 148. Each asset risk score represents a probability that the asset will lead to a financial loss of a business.

In certain embodiments, the asset risk score is a value within a range of 0 to 1000 such that a value of 0 indicates no probability that the asset will lead to financial loss of a business and a value of 1000 indicates a maximum probability that the asset will lead to financial loss of the business. For example, for a particular asset having an asset priority value of 10 and an incident risk score of 100, the asset risk score is 1000, which indicates a maximum probability that the asset will lead to financial loss of the business. As another example, for a particular asset having an asset priority value of 0 and an incident risk score of 0, the asset risk score is 0, which indicates no probability that the asset will lead to financial loss of the business. Method 200 then moves from step 240 to step 255.

If, at step 235, the security tool determines that no incidents are associated with the asset, method 200 advances from step 235 to step 245, where the security tool determines whether one or more incidents are associated with a group of assets. For example, referring to FIG. 1, security tool 144 may determine whether one or more incidents 124 such as data breaches or malware are associated with a group of assets 122. If, at step 245, the security tool determines that one or more incidents are not associated with a group of assets, method 200 advances from step 245 to step 265, where method 200 ends.

If, at step 245, the security tool determines that one or more incidents are associated with a group of assets, method 200 moves from step 245 to step 250, where the security tool generates an asset risk score for the group of assets based on the priority value of the group of assets and the one or more incident risk scores associated with the assets. For example, referring to FIG. 1, security tool 144 may generate asset risk score 152 for group of assets 122 by multiplying asset priority value 150 of asset 122 by incident risk score(s) 148. Each asset risk score represents a probability that the group of assets will lead to a financial loss of a business. Method 200 then moves to step 255.

At step 255 of method 200, the security tool determines whether the asset risk score exceeds a predetermined threshold. For example, referring to FIG. 1, security tool 144 may determine whether asset risk score 152 exceeds threshold 154. In certain embodiments, thresholds are used to classify asset risk scores. For example, an asset (or group of assets) having an asset risk score equal to or above a first threshold of 670 may indicate a high probability that the associated asset (or group of assets) will lead to a financial loss of a business, an asset risk score having a value above a second threshold of 330 but below the first threshold of 670 may indicate a medium probability that associated the asset (or group of assets) will lead to a financial loss of a business, and an asset risk score having a value equal to or below the second threshold of 330 may indicate a low probability that the associated asset (or group of assets) will lead to a financial loss of a business. If the security tool determines that the asset risk score does not exceed the predetermined threshold, method 200 advances from step 255 to step 265, where method 200 ends.

If, at step 255, the security tool determines that the asset risk score exceeds the predetermined threshold, method 200 moves from step 255 to step 260, where the security tool generates an alert for the asset. For example, referring to FIG. 1, security tool 144 may generate alert 156 for asset 122 (or group of assets 122) if asset risk score 152 (e.g., a value of 550 or 730) exceeds threshold 154 (e.g., a value of 670). In certain embodiments, the alert is communicated to a dashboard of a user device. The alert may inform a user of the user device of certain incidents/assets that require immediate attention. Method 200 then moves from step 260 to step 265, where method 200 ends. As such, method 200 allows administrators to quickly determine which assets are more likely to lead to a financial loss of a business.

Although this disclosure describes and illustrates particular steps of method 200 of FIG. 2 as occurring in a particular order, this disclosure contemplates any suitable steps of method 200 of FIG. 2 occurring in any suitable order. For example, step 230 directed to determining a priority value for an asset may occur before step 210 directed to receiving assets and incidents from an infrastructure. Although this disclosure describes and illustrates an example method 200 for generating risk scores based on actual loss events including the particular steps of the method of FIG. 2, this disclosure contemplates any suitable method for generating risk scores based on actual loss events, which may include all, some, or none of the steps of the method of FIG. 2, where appropriate. Although FIG. 2 describes and illustrates particular components, devices, or systems carrying out particular actions, this disclosure contemplates any suitable combination of any suitable components, devices, or systems carrying out any suitable actions.

FIG. 3 illustrates an example computer system 300. In particular embodiments, one or more computer system 300 perform one or more steps of one or more methods described or illustrated herein. In particular embodiments, one or more computer system 300 provide functionality described or illustrated herein. In particular embodiments, software running on one or more computer system 300 performs one or more steps of one or more methods described or illustrated herein or provides functionality described or illustrated herein. Particular embodiments include one or more portions of one or more computer system 300. Herein, reference to a computer system may encompass a computing device, and vice versa, where appropriate. Moreover, reference to a computer system may encompass one or more computer systems, where appropriate.

This disclosure contemplates any suitable number of computer system 300. This disclosure contemplates computer system 300 taking any suitable physical form. As example and not by way of limitation, computer system 300 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 300 may include one or more computer system 300; be unitary or distributed; span multiple locations; span multiple machines; span multiple data centers; or reside in a cloud, which may include one or more cloud components in one or more networks. Where appropriate, one or more computer system 300 may perform without substantial spatial or temporal limitation one or more steps of one or more methods described or illustrated herein. As an example and not by way of limitation, one or more computer system 300 may perform in real time or in batch mode one or more steps of one or more methods described or illustrated herein. One or more computer system 300 may perform at different times or at different locations one or more steps of one or more methods described or illustrated herein, where appropriate.

In particular embodiments, computer system 300 includes a processor 302, memory 304, storage 306, an input/output (I/O) interface 308, a communication interface 310, and a bus 312. Although this disclosure describes and illustrates a particular computer system having a particular number of particular components in a particular arrangement, this disclosure contemplates any suitable computer system having any suitable number of any suitable components in any suitable arrangement.

In particular embodiments, processor 302 includes hardware for executing instructions, such as those making up a computer program. As an example and not by way of limitation, to execute instructions, processor 302 may retrieve (or fetch) the instructions from an internal register, an internal cache, memory 304, or storage 306; decode and execute them; and then write one or more results to an internal register, an internal cache, memory 304, or storage 306. In particular embodiments, processor 302 may include one or more internal caches for data, instructions, or addresses. This disclosure contemplates processor 302 including any suitable number of any suitable internal caches, where appropriate. As an example and not by way of limitation, processor 302 may include one or more instruction caches, one or more data caches, and one or more translation lookaside buffers (TLBs). Instructions in the instruction caches may be copies of instructions in memory 304 or storage 306, and the instruction caches may speed up retrieval of those instructions by processor 302. Data in the data caches may be copies of data in memory 304 or storage 306 for instructions executing at processor 302 to operate on; the results of previous instructions executed at processor 302 for access by subsequent instructions executing at processor 302 or for writing to memory 304 or storage 306; or other suitable data. The data caches may speed up read or write operations by processor 302. The TLBs may speed up virtual-address translation for processor 302. In particular embodiments, processor 302 may include one or more internal registers for data, instructions, or addresses. This disclosure contemplates processor 302 including any suitable number of any suitable internal registers, where appropriate. Where appropriate, processor 302 may include one or more arithmetic logic units (ALUs); be a multi-core processor; or include one or more processors 302. Although this disclosure describes and illustrates a particular processor, this disclosure contemplates any suitable processor.

In particular embodiments, memory 304 includes main memory for storing instructions for processor 302 to execute or data for processor 302 to operate on. As an example and not by way of limitation, computer system 300 may load instructions from storage 306 or another source (such as, for example, another computer system 300) to memory 304. Processor 302 may then load the instructions from memory 304 to an internal register or internal cache. To execute the instructions, processor 302 may retrieve the instructions from the internal register or internal cache and decode them. During or after execution of the instructions, processor 302 may write one or more results (which may be intermediate or final results) to the internal register or internal cache. Processor 302 may then write one or more of those results to memory 304. In particular embodiments, processor 302 executes only instructions in one or more internal registers or internal caches or in memory 304 (as opposed to storage 306 or elsewhere) and operates only on data in one or more internal registers or internal caches or in memory 304 (as opposed to storage 306 or elsewhere). One or more memory buses (which may each include an address bus and a data bus) may couple processor 302 to memory 304. Bus 312 may include one or more memory buses, as described below. In particular embodiments, one or more memory management units (MMUs) reside between processor 302 and memory 304 and facilitate accesses to memory 304 requested by processor 302. In particular embodiments, memory 304 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 304 may include one or more memories 304, where appropriate. Although this disclosure describes and illustrates particular memory, this disclosure contemplates any suitable memory.

In particular embodiments, storage 306 includes mass storage for data or instructions. As an example and not by way of limitation, storage 306 may include a hard disk drive (HDD), a floppy disk drive, flash memory, an optical disc, a magneto-optical disc, magnetic tape, or Universal Serial Bus (USB) drive or a combination of two or more of these. Storage 306 may include removable or non-removable (or fixed) media, where appropriate. Storage 306 may be internal or external to computer system 300, where appropriate. In particular embodiments, storage 306 is non-volatile, solid-state memory. In particular embodiments, storage 306 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 306 taking any suitable physical form. Storage 306 may include one or more storage control units facilitating communication between processor 302 and storage 306, where appropriate. Where appropriate, storage 306 may include one or more storages 306. Although this disclosure describes and illustrates particular storage, this disclosure contemplates any suitable storage.

In particular embodiments, I/O interface 308 includes hardware, software, or both, providing one or more interfaces for communication between computer system 300 and one or more I/O devices. Computer system 300 may include one or more of these I/O devices, where appropriate. One or more of these I/O devices may enable communication between a person and computer system 300. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 308 for them. Where appropriate, I/O interface 308 may include one or more device or software drivers enabling processor 302 to drive one or more of these I/O devices. I/O interface 308 may include one or more I/O interfaces 308, where appropriate. Although this disclosure describes and illustrates a particular I/O interface, this disclosure contemplates any suitable I/O interface.

In particular embodiments, communication interface 310 includes hardware, software, or both providing one or more interfaces for communication (such as, for example, packet-based communication) between computer system 300 and one or more other computer system 300 or one or more networks. As an example and not by way of limitation, communication interface 310 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 310 for it. As an example and not by way of limitation, computer system 300 may communicate with an ad hoc network, a personal area network (PAN), a LAN, a WAN, a MAN, or one or more portions of the Internet or a combination of two or more of these. One or more portions of one or more of these networks may be wired or wireless. As an example, computer system 300 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network, a 3G network, a 4G network, a 5G network, an LTE network, or other suitable wireless network or a combination of two or more of these. Computer system 300 may include any suitable communication interface 310 for any of these networks, where appropriate. Communication interface 310 may include one or more communication interfaces 310, where appropriate. Although this disclosure describes and illustrates a particular communication interface, this disclosure contemplates any suitable communication interface.

In particular embodiments, bus 312 includes hardware, software, or both coupling components of computer system 300 to each other. As an example and not by way of limitation, bus 312 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 312 may include one or more buses 312, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A network component comprising one or more processors and one or more computer-readable non-transitory storage media coupled to the one or more processors and including instructions that, when executed by the one or more processors, cause the network component to perform operations comprising:
determining an attack tactic risk score for one or more attack tactics based on a dataset of actual loss events;
determining an incident risk score for an incident based on the one or more attack tactic risk scores;
determining a priority value for an asset, wherein the asset is associated with the incident; and
generating an asset risk score for the asset based on the priority value of the asset and the incident risk score.

2. The network component of claim 1, wherein the incident risk score is associated with a probability that the incident will lead to a financial loss of a business.

3. The network component of claim 1, wherein the incident risk score is associated with one of the following:
a highest attack tactic risk score of the one or more attack tactics; or
an average attack tactic risk score of the one or more attack tactics.

4. The network component of claim 1, wherein generating the asset risk score for the asset comprises multiplying the priority value of the asset by the incident risk score.

5. The network component of claim 1, wherein:
the incident risk score is one of a plurality of incident risk scores associated with the asset; and
generating the asset risk score for the asset is based on the priority value of the asset and the plurality of incident risk scores.

6. The network component of claim 1, wherein:
the attack tactic risk score for each of the one or more attack tactics is a value within a range of 1 to 100;
the incident risk score for the incident is a value within a range of 1 to 100; and
the priority value of the asset is a value within a range of 1 to 10; and
the asset risk score is a value within a range of 1 to 1000.

7. The network component of claim 1, wherein the dataset of actual loss events comprises breach data and insurance data.

8. A method, comprising:
determining an attack tactic risk score for one or more attack tactics based on a dataset of actual loss events;
determining an incident risk score for an incident based on the one or more attack tactic risk scores;
determining a priority value for an asset, wherein the asset is associated with the incident; and
generating an asset risk score for the asset based on the priority value of the asset and the incident risk score.

9. The method of claim 8, wherein the incident risk score is associated with a probability that the incident will lead to a financial loss of a business.

10. The method of claim 8, wherein the incident risk score is associated with one of the following:
a highest attack tactic risk score of the one or more attack tactics; or an average attack tactic risk score of the one or more attack tactics.

11. The method of claim 8, wherein generating the asset risk score for the asset comprises multiplying the priority value of the asset by the incident risk score.

12. The method of claim 8, wherein:
the incident risk score is one of a plurality of incident risk scores associated with the asset; and
generating the asset risk score for the asset is based on the priority value of the asset and the plurality of incident risk scores.

13. The method of claim 8, wherein:
the attack tactic risk score for each of the one or more attack tactics is a value within a range of 1 to 100;
the incident risk score for the incident is a value within a range of 1 to 100; and
the priority value of the asset is a value within a range of 1 to 10; and
the asset risk score is a value within a range of 1 to 1000.

14. The method of claim 8, wherein the dataset of actual loss events comprises breach data and insurance data.

15. One or more computer-readable non-transitory storage media embodying instructions that, when executed by a processor, cause the processor to perform operations comprising:
determining an attack tactic risk score for one or more attack tactics based on a dataset of actual loss events;
determining an incident risk score for an incident based on the one or more attack tactic risk scores;
determining a priority value for an asset, wherein the asset is associated with the incident; and
generating an asset risk score for the asset based on the priority value of the asset and the incident risk score.

16. The one or more computer-readable non-transitory storage media of claim 15, wherein the incident risk score is associated with a probability that the incident will lead to a financial loss of a business.

17. The one or more computer-readable non-transitory storage media of claim 15, wherein the incident risk score is associated with one of the following:
a highest attack tactic risk score of the one or more attack tactics; or
an average attack tactic risk score of the one or more attack tactics.

18. The one or more computer-readable non-transitory storage media of claim 15, wherein generating the asset risk score for the asset comprises multiplying the priority value of the asset by the incident risk score.

19. The one or more computer-readable non-transitory storage media of claim 15, wherein:
the incident risk score is one of a plurality of incident risk scores associated with the asset; and
generating the asset risk score for the asset is based on the priority value of the asset and the plurality of incident risk scores.

20. The one or more computer-readable non-transitory storage media of claim 15, wherein:
the attack tactic risk score for each of the one or more attack tactics is a value within a range of 1 to 100;
the incident risk score for the incident is a value within a range of 1 to 100; and
the priority value of the asset is a value within a range of 1 to 10; and
the asset risk score is a value within a range of 1 to 1000.
